(19) United States
(12) Patent Application Publication
(10) Pub. No.: US 2016/0265753 A1
(43) Pub. Date: Sep. 15, 2016

(54) Lighted Marker

(71) Applicant: Jenesis International Inc., Benton Harbor, MI (US)

(72) Inventors: Bradford B. Jensen, Saint Joseph, MI (US); Kim I. McCavit, Saint Joseph, MI (US)

(73) Assignee: Jenesis International Inc., Benton Harbor, MI (US)

(21) Appl. No.: 15/050,675

(22) Filed: Feb. 23, 2016

Related U.S. Application Data
(60) Provisional application No. 62/130,396, filed on Mar. 9, 2015.

(51) Int. Cl. F21V 21/08; F21V 23/00; F21S 9/02

(52) U.S. Cl. CPC F21V 21/0824; F21S 9/02; F21V 23/003; F21Y 2101/02

(57) ABSTRACT

A lighted marker for driveways, sidewalks and other various uses. The lighted marker includes a loweer housing and an upper housing. A module including an LED coupled to a battery and a circuit adapted to energize the LED is received in the lower housing through an opening. The upper housing fits over the lower housing preventing water from entering the opening. Alternatively, the module is rigidly secured to the upper housing. The upper housing includes a translucent plastic surface surrounding the LED and viewable from a 360° field of view. The LED lights the translucent surface and the upper housing surface can thereby be seen with night adjusted eyes. The lighted marker is adapted to fit on and preferably be demountably mounted on a fiberglass rod shaped stake which is adapted to be driven into the ground. An umbilical cord is attached between the stake and the lower housing.

### CROSS REFERENCE TO RELATED APPLICATIONS

This application claims priority under 35 U.S.C. 119(e) of U.S. provisional patent application Ser. No. 62/130,396 filed on Mar. 9, 2015 entitled DRIVEWAY MARKER LIGHT the disclosure of which is hereby incorporated herein by reference.

### BACKGROUND OF THE INVENTION

1. Field of the Invention

The present invention relates to battery powered marker driveways, parking lots, sidewalks, etc.

2. Background

Finding the location of the edges of driveways, parking lots, sidewalks, etc. is often difficult either at night, or also when there is snow covering all of the normally visible reference points. As a result for many years a wide range of marking products have been designed and made widely available to consumers. The most common of these in recent years are low-cost fiberglass stakes (see FIG. 2), which because of their small diameter are relatively easy to install with a modest amount of three in typical soils. Fiberglass stakes also have an advantage that they are relatively flexible, so they can tolerate a range of impacts by vehicles before they break. Also because they have a slender profile, they are not as aesthetically distracting as older style markers.

To aid seeing driveway markers at night, fiberglass stakes typically have a reflective paint or tape applied on a section near the top. This works by reflecting light back towards it's source, which helps to make whatever they are attached to visible. However, because fiberglass stakes are relatively slender, the amount of space available for reflective material is relatively small. Other older types of reflectors solve the problem of a small reflective surface by creating a large round (see FIG. 1) or rectangular reflector at the top of a metal stake. These are typically made with a polished aluminum reflector behind a plastic piece Which has a range of prismatic surfaces which cause the reflection to have a wider range. These are seen widely in rural areas to mark the entrance to driveways. Their application however is typically limited because they are not very aesthetically pleasing, and also typically have a larger stake which may be harder to install and also adding to diminished aesthetic appeal. Most typical reflectors are two sided, so have a limited orientation over which there is a strong reflection. Some reflectors attempt to get past that issue with a reflector which is 4 sided. Because of that, these are much larger, and so there are aesthetic disadvantages. 4-sided reflectors are typically combined with a much larger diameter plastic stake, so the proportions of the product look more aesthetically pleasing. One of the limitations in all of these reflector approaches at night is that they need a very intense light source to hit them so there is a reasonable reflection. As well, the orientation of the reflector is important or there can be no effective reflection. It has been observed that headlights under optimal conditions can produce a very strong reflection and good marking properties. However, lower intensity light, such as a rear backup lights, do not produce a very strong a reflection. As a consequence reflectors may have only marginal effectiveness when a car is backing up at night as the reflectors are viewed through small rearview mirrors. And this is particularly true of fiberglass stakes with a very small reflective surface area.

Therefore what is needed is a design that is brighter and does not require reflection from an intense light source to be effective. To solve partially that problem, in recent years a number of solar-powered driveway markers (see FIG. 3) have been created. These are able to produce more effective lighting that is visible under adverse applications, such as backing up a car and viewing marked obstructions through a rear view mirror. There are a number of disadvantages however in this approach. The solar panel is typically mounted on the top of the marker, so the solar panel is typically very small. As a consequence it cannot collect a very large charge. Compounding the problem is the widespread use of these products in winter, when day lengths are at their shortest and also the angle of the sun is low in the sky. Easily in most North American locations, the theoretic amount of solar energy available in winter for a horizontal surface can readily be as little as ⅓ of summer charge potential. Cloudy days and shading also create additional problems since the charge can readily be reduced by 90% when conditions are not optimal. As a consequence, because of the limited amount of power available, frequently solar designs blink their light so their net power consumption is much lower than running continuously. In some applications a blinking marker may be very acceptable, but unless it is an application of very high importance, most will object to the poor aesthetics of a large number of blinking tights along a driveway. Another issue with a blinking marker is that they particularly draw attention to themselves, so they become a greater temptation for thieves. It is not uncommon that driveway markers are stolen, since their ease of installation also makes them easy to be removed. Yet another problem is that rechargeable batteries have a limited life and must be replaced every 2-3 years. In many cases the cost of the replacement battery is high, so this creates a dilemma for consumers deciding whether to throw away the product or replace the batteries. Many of these rechargeable batteries require special recycling channels because of the toxic chemicals these contain.

So, what is needed is a marker that is highly visible regardless of a presence of a light source to create a reflection, something that has a pleasant aesthetically pleasing appearance that isn't limited by the availability of sunshine, that doesn't draw unwarranted attention to itself, is low cost and easy to maintain.

### SUMMARY OF THE INVENTION

There are many purposes achieved with the invention. These include a marker light being adaptable to fit on the top of typical fiberglass stakes, which are widely accepted, low cost and readily available in the marketplace.

Another purpose is to attain a small size, so the lit marker is aesthetically acceptable on top of a fiberglass stake.

Yet another purpose is to provide a marker that is continuously lit and viewable from a 360 degree field of view. This also negates the need of a bright light source to provide a reflection. This is particularly helpful for pedestrians and when backing up a car with backup lights that are of a modest intensity.

Another purpose is to provide a lit marker which is lower-cost, and therefore more sustainable utilizing low-cost and readily available batteries. This eliminates the need for additional components such as solar panels, and rechargeable batteries which need to be periodically replaced, and often of the NiCad style which require special disposal procedures compared with alkaline batteries.

Another purpose is to provide a Marker light which has a photocell and can run for 6 months or longer on a battery changing, including designs that utilize just a single battery.

The driveway marker design disclosed is very compact compared with the art and utilizes a single AA battery, although a variety of other battery sizes and types could be used, such as AAA, C, D, and also some of the larger capacity coin cells. The design takes advantage of ubiquitous fiberglass stakes by mounting directly to the top of these. Because the diameter of the marker is relatively modest, the marker tight on the end of a fiberglass rod has an appearance similar to a small cattail, thus drawing modest aesthetic attention to itself, Internally, the bottom portion of the marker light houses the battery, which is mounted within a cartridge type battery carrier, which also provides the support and housing for the electronics. The LED faces upward and lights up a columnar diffuser. A photocell is used in the circuitry so that the LED is only activated when there is sufficient darkness for the light to be effective. The case design allows for simple seasonal battery replacement, and the case is also designed to shed rain and snow away from vulnerable electronics.

This product applies and builds upon the principles of low level marker lighting as described in U.S. Pat. No. 6,992,591. This patent describes a variety of applications which are able to mark the location of various objects at night with eyes that are adapted to using night vision. These all utilize highly efficient LEDs operated at low currents well below their typical range of application, The use of a light diffusing or scattering surface is effective in making a surface appear lit, despite the relatively small amounts of light that are involved, When combined with battery operation, the techniques described in this patent allow the creation of products which can “glow” for very long periods of time, often for a year or longer using conventional readily available batteries.

One embodiment of a battery-powered driveway marker is shown in FIG. 8 of U.S. Pat. No. 6,992,591. This design works well for those applications where cost is not too important and where a larger lit marker like a long tube is desirable. This aches the elemental ideas involved to create a marker using an LED, batteries, with a large diffusing surface. However it does not show a much more desirable approach which is much lower cost to produce, and is adapted to work with readily available fiberglass stakes. This is also a more sustainable approach that uses few batteries, and uses far less plastic material to accomplish the marker function.

The new marker has a number of advantages over what has been known in the art. The light level the marker light can produce is very adequate to mark the location. The lit diffuser is visible over a 360 degree field of view, and isn't subject to the limited field of view of typical reflector products that require a high intensity light hitting it's reflective surface to allow a proper reflection. In addition, since it doesn't require a reflected light source, the marker is visible to pedestrians and others with no light source available to shine on the marker.

For winter application the current consumption can be set to run for 6 months using AA batteries which covers the full winter period in areas that use marker lights during the snow removal season. By use of the marker ht concepts as described in U.S. Pat. No. 6,992,591, there is reasonable battery capacity available to allow the marker to run dusk-to-dawn with a continuous glow rather than blinking the LED light source. Another advantage of a continuous glow is that the markers are readily seen by those looking for them, but do not draw unwarranted attention to themselves, thereby reducing the temptation to thieves.

In one form thereof, the present invention is directed to a lighted marker including a marker light having an LED coupled to a battery and a circuit adapted to selectively energize the LED. A translucent plastic surface at least partially surrounds the LED. Light emitted by the LED lights the translucent surface whereby the surface can be seen with light adjusted eyes. The marker light includes a hole sized to selectively receive a terminal end of and fit on a stake.

Preferably, the marker light is selectively demountably mounted on the terminal end of the stake An umbilical cord is permanently attached to the stake and the marker light whereby the marker light can be demounted but not separated from the stake. The hole is preferably cylindrical and is sized to selectively receive a rod shaped stake terminal end. The marker light preferably has an outer diameter which is less than three times the diameter of the rod shaped stake. The translucent plastic surface is preferably viewable from a 360° field of view.

In another form thereof, the present invention is directed to a lighted marker including a lower housing having an LED coupled to a battery and a circuit adapted to selectively energize the LED. The lower housing is adapted to fit on a stake. An upper housing is coupled to the lower housing and includes a translucent plastic surface at least partially surrounding the LED. Light emitted by the LED lights the translucent surface whereby the translucent s face can be seen with night adjusted eyes.

Preferably, the lower housing includes a cylindrical hole sized to selectively receive a rod shaped terminal end of the stake whereby the lower housing is demountably mounted on and fit on the stake. An umbilical cord is preferably permanently attached to the stake and the lower housing whereby, when the stake terminal end is removed from the lower housing hole, the lower housing is not separated from he stake. Preferably, the lower and upper housings have outer diameters which are less than three times the diameter of the stake. The elongate rod shaped stake is preferably made of fiberglass. The translucent plastic surface is preferably viewable from a 360° field of view.

In another form thereof, the present invention is directed to a driveway marker including an elongate rod shaped stake made of fiberglass and adapted to be driven into the ground. A marker light is provided at one terminal end of the stake. The marker light includes an LED coupled to a battery and a circuit adapted to selectively energize the LED and, also, a translucent plastic surface at least partially surrounding the LEDA. Accordingly, light emitted by the LED lights the translucent surface whereby it can be seen with night adjusted eyes.

Preferably, the marker light is demountably mounted on the stake terminal end. In this regard, the marker light can include a cylindrical hole sized to selectively receive the stake terminal end thereby the marker light is demountably mounted on the stake. An umbilical cord is permanently attached to the stake and the marker light whereby, when the stake terminal end is removed from the marker light hole, the marker light is not separated from the stake. The marker light has an outer diameter which is less than three times the diameter of the rod shaped stake.

In another form thereof, the present invention is directed to a driveway marker including an elongate rod shaped stake adapted to be driven into the ground. A lower housing is provided at one terminal end of the stake. The lower housing includes an LED coupled to a battery and a circuit adapted to selectively energize the LED. An upper housing is coupled to the lower housing. The upper housing includes a translucent plastic surface viewable from a 360° field of view and at least partially surrounds the LED. Accordingly, light emitted by the LED lights the translucent surface whereby the translucent surface can be seen with night adjusted eyes.

Preferably, the lower housing includes a cylindrical hole sized to selectively receive the stake terminal end whereby the lower housing is demountably mounted on the stake. An umbilical cord is permanently attached to the stake and the lower housing whereby, when the stake terminal end is removed from the lower housing hole, the lower housing is not separated from the stake. The lower and upper housings preferably have outer diameters which are less than three times the diameter of the rod shaped stake, and the stake is made of fiberglass.

In yet another form thereof, the present invention is directed to a driveway marker including an elongate rod shaped stake adapted to be driven into the ground. A lower housing having a cylindrical hole at one terminal end thereof and a cavity opening at its other opposite terminal end is provided and the cylindrical hole sized to selectively receive the stake terminal end whereby the lower housing is demountably mounted o the stake. A module is provided including an LED coupled to a battery and a circuit adapted to selectively energize the LED. The module is received in the lower housing through the cavity opening with the LED facing away from the lower housing. An upper housing is coupled to the lower housing. The upper housing includes a translucent plastic surface viewable from a 360° field of view and at least partially surrounding the LED. Accordingly, light emitted by the LED lights the translucent surface whereby the translucent surface can be seen with night adjusted eyes.

Preferably, an umbilical cord is permanently attached to the stake and the lower housing whereby, hen the stake terminal end is removed from the lower housing hole, the lower housing is not separated from the stake. The lower and upper housings preferably have outer diameters which are less than three times the diameter of the rod shaped stake. The upper housing forms a cover and fits over the lower housing whereby water traveling over the upper housing toward the lower housing is prevented from entering the lower housing cavity opening. The LED is mounted on a PCB and the PCB is mounted on the module. Alternatively, the module is rigidly secured to the upper housing. The stake can be made of fiberglass.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is a typical reflector based driveway marker;

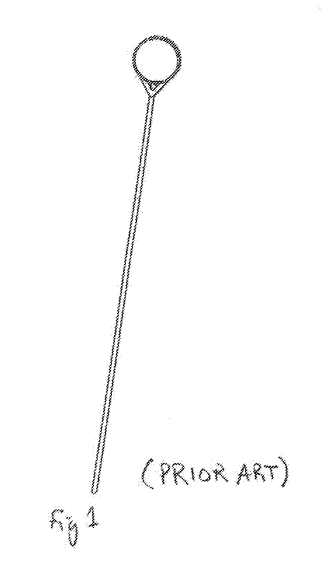

FIG. 2 is atypical fiberglass marker stake;

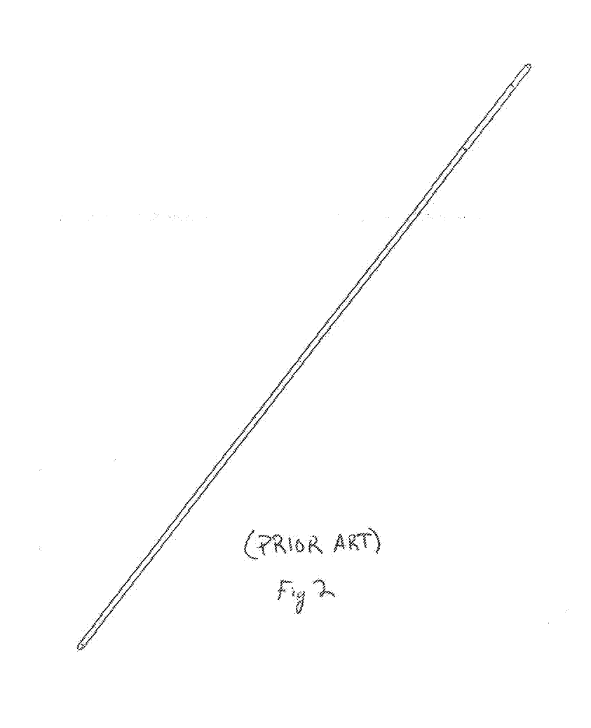

FIG. 3 is a typical solar driveway marker;

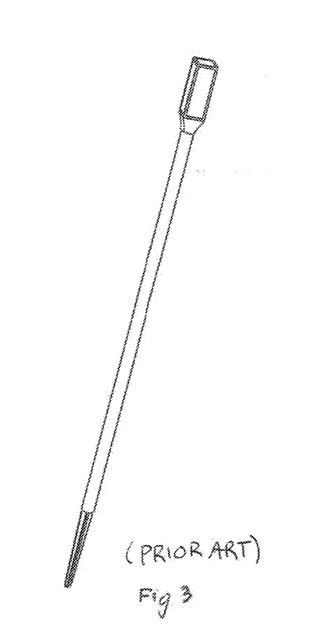

FIG. 4 is a view of the marker light invention as mounted on a fiberglass marker stake;

FIG. 5 is an external view of the marker light invention showing the key visible external features;

FIG. 6 is a section view of the marker light invention showing the internal structures;

FIG. 7 is a view which shows the removable battery cartridge which also holds the electronics; and,

FIG. 8 is an electronics schematic of the marker light invention.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

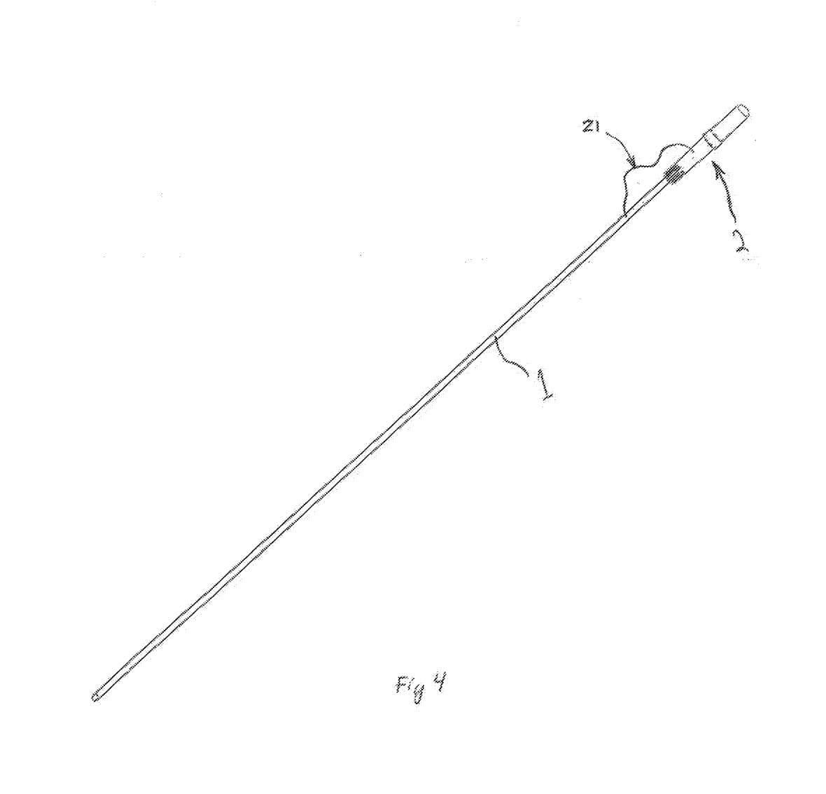

FIG. 4 shows a typical fiberglass stake 1, with the marker light 2. The marker light 2 has a cylindrical hole 14 which is sized to accommodate the fiberglass stake 1, The resulting diameter of the marker light 2 is a ratio of less than 4 times the size of the stake diameter, and as embodied with a AA battery is less than a ratio of 3 times, which is aesthetically pleasing. The marker light 2 can be permanently bonded or glued to the stake, or can be removable, so that a hammer can be used to drive the stake.

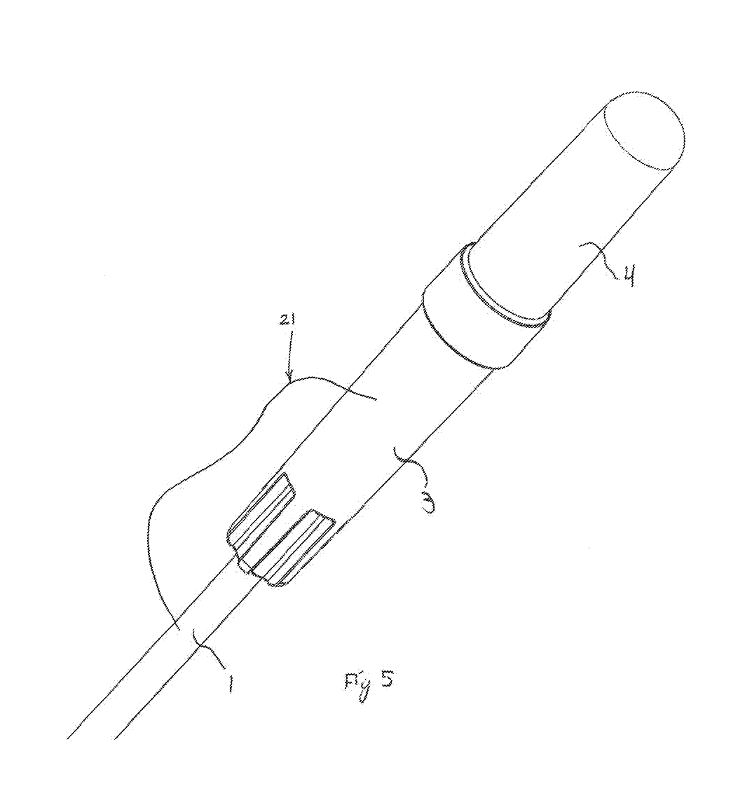

The housing shown in FIG. 5 is composed of two pieces which are visible on the exterior of the product. The lower housing 3, would typically consist of a UV resistant plastic which is opaque to hide the internal workings of the product. The upper housing 4 of the product is a translucent UV resistant plastic which is intended to scatter the light creating a literature substantially along its length. The function of upper housing 4 is not to transmit light through the plastic, but rather tight the surface of the plastic brightly so that it is easy to see with eyes that are night adjusted. To provide water-shedding ability, the upper case 4 fits over the lower case 3. This eliminates the need for a gasket between the case parts which reduces cost and also eliminates a potential failure point. The upper housing 4 is removable to provide access to the battery module. The connection of the upper housing 4 to the lower housing 3 can be made using a variety of mechanical techniques including threads, bayonet style, and press and snap fit. Another contemplated embodiment is a system whereby an umbilical cord 21 permanently attached to the marker light and stake provides a way that the marker light can be lifted off the stake, but cannot become separated. This serves two purposes, one is to allow removal of the marker light while the stake is being pounded in. The other is to prevent theft and removal of the marker light from the stake While it is in the retail store.

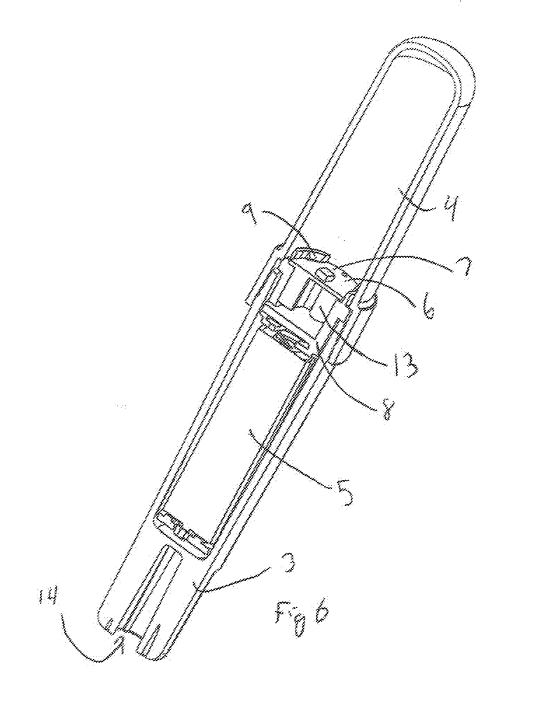

The housing is sectioned in half in FIG. 6, and this shows the key internal components. An LED 7 is positioned on the printed circuit board (PCB) 6 such that it can shine directly on the surfaces of translucent upper housing 4. Not shown in the figure, but in some embodiments there might be a transparent dome-shaped plastic piece which protects the circuit board 6 and LED 7 and is positioned between the PCB 6 and the upper housing 4. The PCB 6 is supported by plastic barbs 9 that hold the edges of the PCB. There are a variety ways in which the PCB 6 may be held in place which could involve sliding mechanism, screws, press fit and glue. The preferred embodiment of this approach provides the most compact PCB 6 size.

Below the PCB 6 area is a cavity 13 which allows space for larger components which might be located on that side. Also not show be a photocell component which senses daylight and prevents the wastage of battery life that would result if the marker light did not shut off during the day. Below the PCB component space is a battery compartment, which contains the battery 5. The battery contacts which are not readily visible are connected through sheet metal strips and wires to the PCB 6.

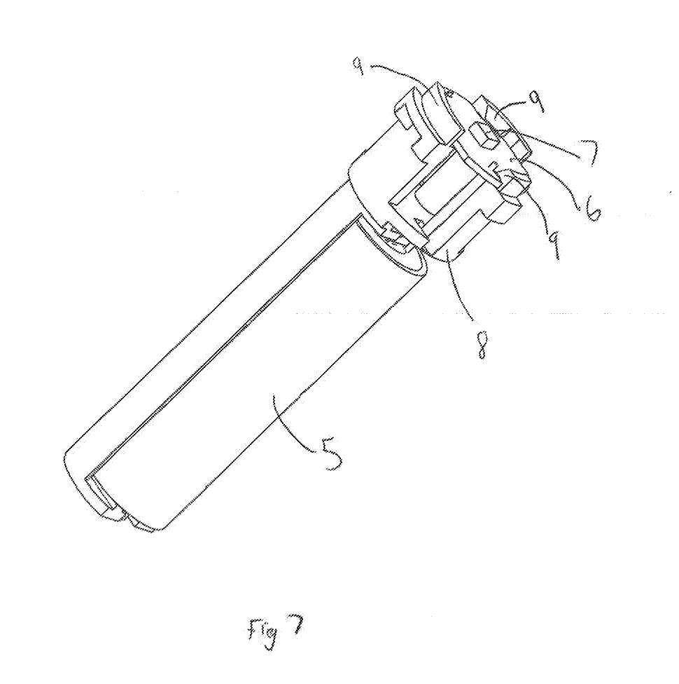

In the preferred embodiment, FIG. 7 shows the battery and PCB module, showing how the battery module can be removed from the lower housing and slid out to make the battery 5 easy to reach and replace. Alternatively, the battery module could also be rigidly attached to the upper case, so that the complete assembly is removed in one piece instead of 2 parts. This also provides permanent protection for the circuitry, which is then never exposed to the consumer.

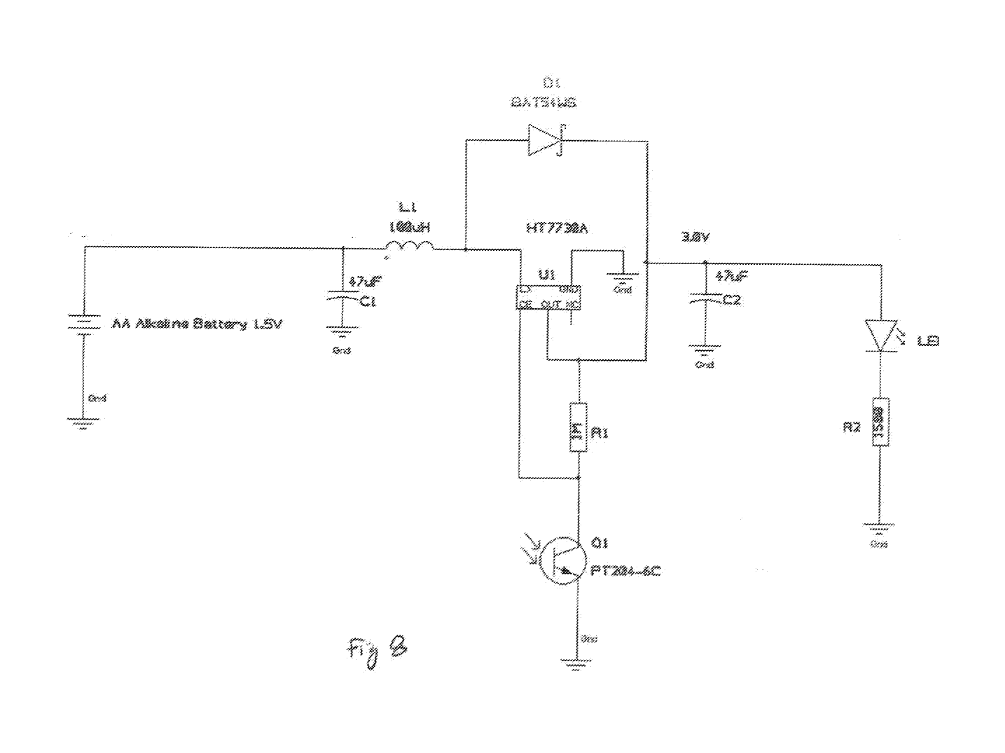

FIG. 8 shows the schematic for one method of creating a low power circuit suitable to drive the LED. The major functions of the circuit are to provide a step-up in voltage, regulate the voltage, provide current setting limits for the LED and provide for photocontrol input.

The voltage required by the white LED in this embodiment is in the range of 3v to 4.5v, so a step-up function is provided to reach the required voltage to drive the LED. Red or amber LEDs could also be used and these would work at lower voltages. The step up circuit is driven by a custom semiconductor, which regulates the voltage to the LED and also has an input for a photocell which is able to turn the output to the LED off during high light conditions when exposed to daylight and provides night-time only operation of the LED.

Beyond a static glow as this circuit provides, there are many options for applications where greater visual impact is required, and it is envisioned that there could be circuits which provide a pulsing light pattern, in addition to typical blinking patterns. A pulsing or blinking pattern allows more current to drive the LED during peak points which is traded off against periods of the pattern when the LED is either off or at a much lower current, so that in the end the overall power consumption is the same and can provide the same battery life as continuously glowing approaches.

There are many different variations and embodiments that incorporate the ideas of this invention. These include different sizes and numbers of batteries, different shapes and sizes of lighted diffusing and scattering components, different ways the case parts might be assembled, and a wide range of drive circuits which can produce different lighting effects. These alternates are well known and understood by those skilled in the art.

While this invention has been described as having an exemplary design, the present invention may be further modified within the spirit and scope of this disclosure. This application is therefore intended to cover any variations, uses, or adaptations of the invention using its general principles.

What is claimed is:

1. A lighted marker comprising:
a marker light, said marker light comprising:
an LED coupled to a battery and a circuit adapted to selectively energize said LED; and,
a translucent plastic surface at least partially surrounding said LED;
wherein light emitted by said LED lights said translucent surface whereby said surface can be seen with night adjusted eyes; and,
said marker light includes a hole sized to selectively receive a terminal end of and fit on a stake.

2. The lighted marker of claim 1 wherein said marker light is selectively demountably mounted on said terminal end of said stake.

3. The lighted marker of claim 2 further comprising an umbilical cord permanently attached to said stake and said marker light whereby said marker light can be demounted but not separated from said stake.

4. The lighted marker of claim I wherein said marker light hole is cylindrical and is sized to selectively receive a rod shaped stake terminal end whereby said marker light is demountably mounted on said stake, and further comprising an umbilical cord permanently attached to said stake and said marker light whereby, when said stake terminal end is removed from said marker light hole, said marker light is not separated from said stake.

5. The lighted marker of claim 1 wherein said translucent plastic surface is viewable from a 360° field of view

6. The lighted marker of claim 1 wherein said marker light has an outer diameter which is less than four times the diameter of said rod shaped stake.

7. A lighted marker comprising:
a lower housing, said lower housing including an LED coupled to a battery and a circuit adapted to selectively energize said LED;
said lower housing being adapted to lit on a stake;
an upper housing coupled to said lower housing, said upper housing including a translucent plastic surface at least partially surrounding said LED; and,
wherein light emitted by said LED lights said translucent surface whereby said translucent surface can be seen with night adjusted eyes.

8. The lighted marker of claim 7 wherein said lower housing includes a hole sized to selectively receive a terminal end of said stake whereby said lower housing can be demountably mounted on and fit on said stake, and further comprising an umbilical cord permanently attached to said stake and said lower housing whereby said lower housing can be demounted but not separated from said stake.

9. The lighted marker of claim 7 wherein said translucent plastic surface is viewable from a 360° field of view.

10. The lighted marker of claim 7 wherein said lower housing includes a cylindrical hole sized to selectively receive a rod shaped terminal end of said stake whereby said lower housing is demountably mounted on and fit on said stake.

11. The lighted marker of claim 10 further comprising an umbilical cord permanently attached to said stake and said lower housing whereby, when said stake terminal end is removed from said lower housing hole, said lower housing is not separated from said stake.

12. The lighted marker of claim 10 wherein said lower and upper housings have outer diameters which are less than four times the diameter of said stake.

13. The lighted marker of claim 10 wherein said elongate rod shaped stake is made of fiberglass.

14. A lighted marker comprising:
an elongate rod shaped stake adapted to be driven into the ground;
a lower housing comprising a hole at one terminal end thereof and a cavity opening at its other opposite terminal end;
said hole sized to selectively receive a terminal end of said stake whereby said lower housing is demountably mounted on said stake;
a module including an LED coupled to a battery and a circuit adapted to selectively energize said LED;
said module received in said lower housing through said cavity opening with said LED facing away from said lower housing;
an upper housing coupled to said lower housing, said upper housing including a translucent plastic surface viewable from a 360° field of view and at least partially surrounding said LED; and,
wherein light emitted by said LED lights said translucent surface Whereby said translucent surface can be seen with night adjusted eyes.

15. The lighted marker of claim 14 further comprising an umbilical cord permanently attached to said stake and said lower housing whereby, when said stake terminal end is removed from said lower housing hole, said lower housing is not separated from said stake.

16. The lighted marker of claim 14 wherein said lower and upper housings have outer diameters which are less than four times the diameter of said rod shaped stake.

17. The lighted marker of claim 14 wherein said upper housing forms a cover and fits over said lower housing whereby water traveling over said upper housing toward said lower housing is prevented from entering said lower housing cavity opening.

18. The lighted marker of claim 14 wherein said LED is mounted on a PCB and said PCB is mounted on said module.

19. The lighted marker of claim 14 wherein said module is rigidly secured to said upper housing.

20. The lighted marker of claim 14 wherein said elongate rod shaped stake is made of fiberglass.

21. The lighted marker of claim 14 wherein said terminal end of said stake and said lower housing hole are cylindrical shaped.
